(19) United States
(12) Patent Application Publication
(10) Pub. No.: US 2013/0048680 A1
(43) Pub. Date: Feb. 28, 2013

(54) QUANTITATIVE DISPENSER

(71) Applicant: HSIEH-MIN TU, TAINAN (TW)

(72) Inventor: HSIEH-MIN TU, TAINAN (TW)

(21) Appl. No.: 13/218,716

(22) Filed: Aug. 26, 2011

(51) Int. Cl. G01F 11/00

(52) U.S. Cl. 222/310

(57) ABSTRACT

A quantitative dispenser is disclosed. The quantitative dispenser includes a container body, a rod, a connection base, an elastic part, and a pressing element. The container body consists of a first space with an isolation ring and a second space. The rod is passed into the first space and the second space. One end of the rod in the first space is through the elastic part and is connected to the pressing element while the other end of the rod is with a pull part. A bottom of the first space is connected to the connection base and a bottom of the rod is inserted into a material discharge opening of the connection base so as to close the material discharge opening. By pressing and releasing the pressing element, a gap is formed between the rod and the material discharge opening and a constant amount of seasoning falls off.

### BACKGROUND OF THE INVENTION

1. Field of the Invention

The present invention relates to a quantitative dispenser, and in particular, to a quantitative dispenser used to dispense a constant amount of seasoning powder. At the same time, the quantitative dispenser can stir the seasoning so as to prevent caking.

2. Description of Related Art

Seasoning is for improving the flavor of food. According to users' eating habits, various kinds and amount of seasoning are added to food for individual's specific needs. However, seasoning containers available on the market now is unable to permit a certain amount of seasoning to be poured out. The user generally estimate the amount of seasoning added visually. Thus the amount is always under- or overestimated. In order to avoid the conditions mentioned above, users can use various types of spoons to add the seasoning powder. Unfortunately, how to add a proper amount of seasoning is still a problem. This bothers many users.

The seasoning containers available now have many shortcomings while in use and there is room for improvement.

### SUMMARY OF THE INVENTION

Therefore it is a primary object of the present invention to provide a quantitative dispenser by which only a constant amount of seasoning comes out each time. At the same time, the quantitative dispenser prevents caking and bridging of powdered seasoning.

In order to achieve the above object, a quantitative dispenser of the present invention includes a container body, a rod inserted through the container body and arranged with a pull part thereof, a connection base connected to a bottom end of the container body, an elastic part placed around the rod and providing elasticity to the rod while the rod being pressed, and a pressing element arranged at a top of the rod. An isolation ring is arranged at a first space of the container body so as to limit downward travel of the pressing element and control a gap size between the rod and the material discharge opening of the connection base. Thus the amount of seasoning dispensed is fixed. Moreover, while the rod is moving, the pull part disposed on the rod is also moved along with the rod to stir the seasoning for preventing caking and bridging.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment of a quantitative dispenser according to the present invention;

FIG. 2 is an assembled cross sectional view of an embodiment when a pressing element is not pressed yet according to the present invention;

FIG. 3 is a partial enlarged view of the embodiment in FIG. 2;

FIG. 4 is an assembled cross sectional view of an embodiment while a pressing element is pressed according to the present invention;

FIG. 5 is a partial enlarged view of the embodiment in FIG. 4;

FIG. 6 is a schematic drawing showing an embodiment in use while a pressing element is not pressed according to the present invention;

FIG. 7 is a schematic drawing showing an embodiment in use while a pressing element is pressed according to the present invention.

### DETAILED DESCRIPTION OF THE PREFERRED EMBODIMENT

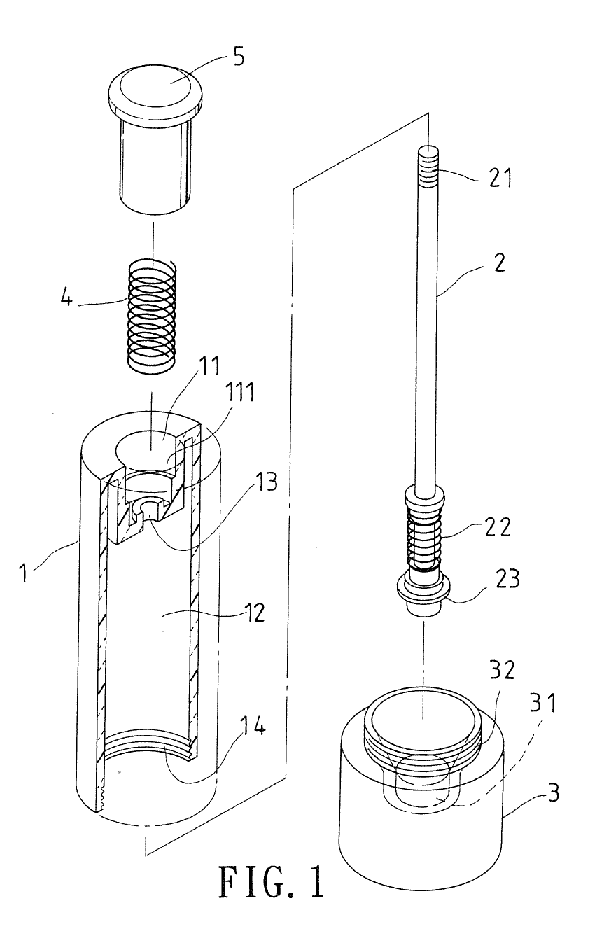

Refer to FIG. 1, a quantitative dispenser of the present invention includes a container body 1, a rod 2, a connection base 3, an elastic part 4 and a pressing element 5.

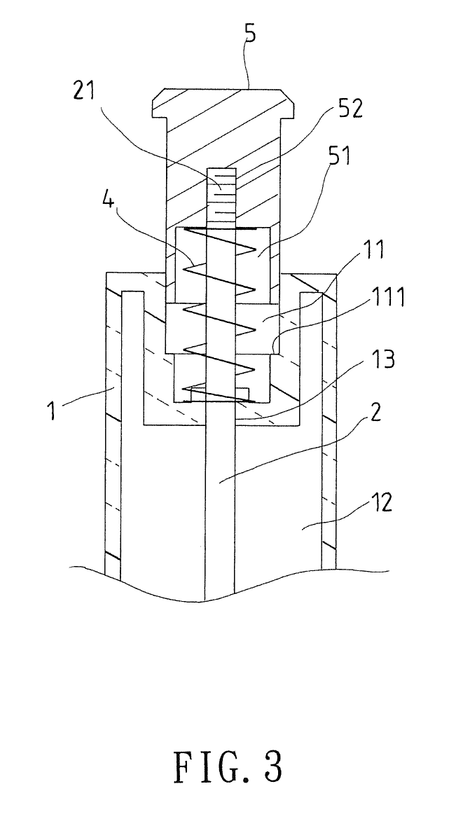

Inside the container body 1, there is a first space 11, a second space 12 and an insertion hole 13 connecting and between the first space 11 and the second space 12. An isolation ring 111 is disposed around a cylindrical wall of the first space 11, as shown in FIG. 3. An opening of the first space 11 is facing upward while an opening of the second space 12 is facing downward. A threaded segment 14 is set on an inner wall surface at one end of the second space 12, near the opening.

The rod 2 includes an assembly part 21 disposed on a top end thereof, a pull part 22 and a seal 23 arranged at a bottom end in turn thereof.

The connection base 3 consists of a material discharge opening 31 therein and a threaded segment 32 on a top end thereof. The material discharge opening 31 is conical.

The elastic part 4 is mounted inside the first space 11 of the container body 1.

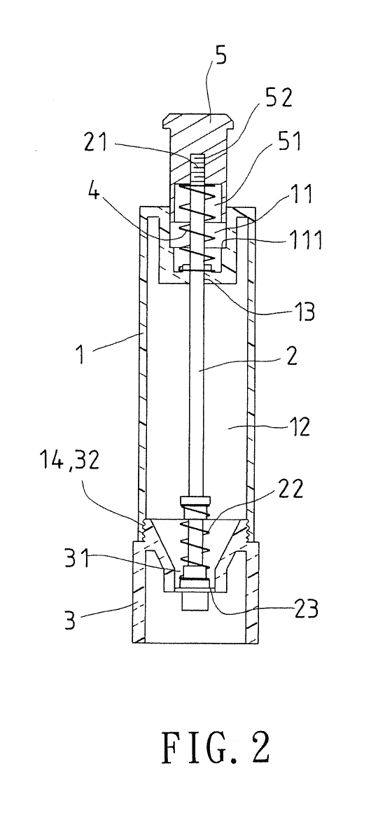

Refer to FIG. 2 and FIG. 3, the pressing element 5 is set on the first space 11 of the container body 1 and is having a receiving space 51 whose opening is facing downward, and a threaded hole 52 arranged concavely at the receiving space 51.

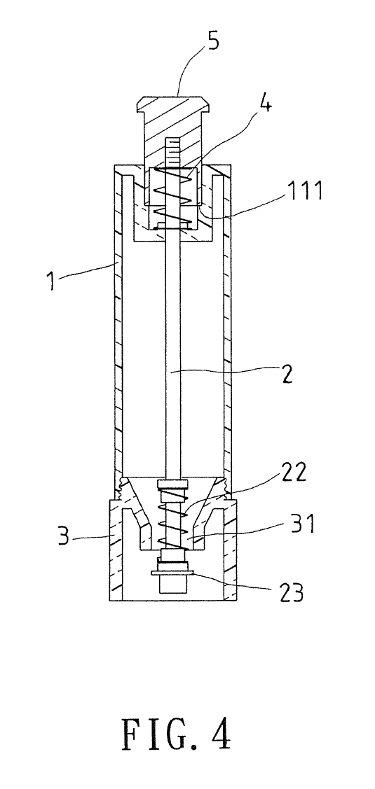

While being assembled, refer from FIG. 2 to FIG. 5, the rod 2 is inserted into the second space 12 and the top end of the rod 2 is passed through the insertion hole 13 and entered into the first space 11 of the container body 1. Then the rod 2 is passed through the elastic part 4 and the assembly part 21 of the rod 2 is threaded and fixed into the threaded hole 52 of the pressing element 5. The connection between the rod 2 and the pressing element 5 is completed. Next the threaded segment 32 of the connection base 3 and the threaded segment 14 of the container body 1 are threaded and fixed with each other. Thus the connection base 3 is connected to the opening on one end of the second space 12 of the container body 1. The bottom end of the rod 2 is inserted into the material discharge opening 31 of the connection base 3 and then the seal 23 is used to close the material discharge opening 31.

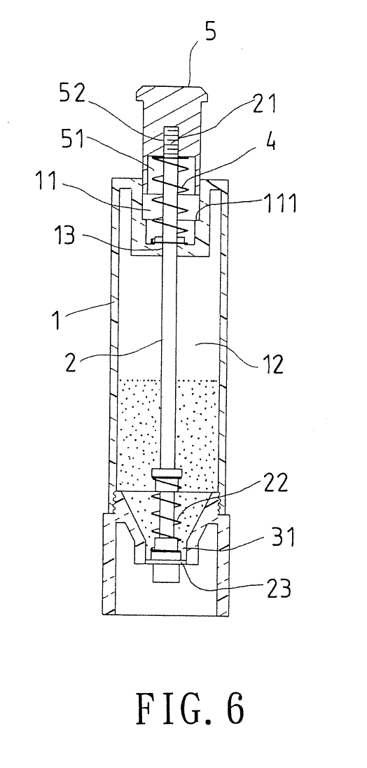

Refer to FIG. 6, the rod 2 is against by an elastic force from the elastic part 4 to be located at an ascending position. The seal 23 of the rod 2 is used to close the material discharge opening 31 of the connection base 3.

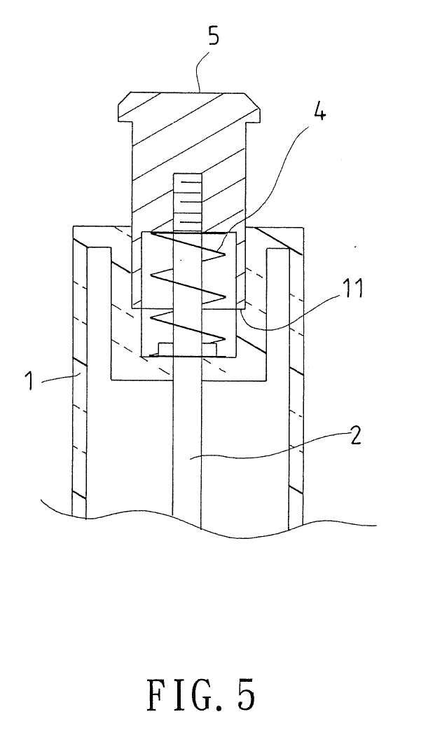

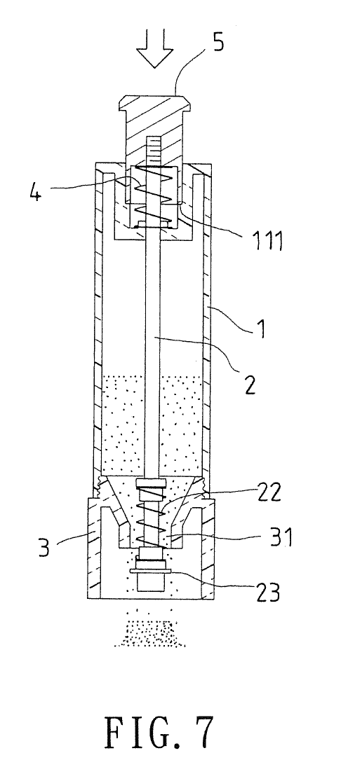

Refer to FIG. 5 and FIG. 7, while the pressing element 5 being pressed, the pressing element 5 is stopped by the isolation ring 111 of the first space 11 and the rod 2 is on a terminal end of a descending position. Now there is a gap between the seal 23 of the rod 2 and the material discharge opening 31 of the connection base 3 so that some seasoning falls off. After the pressing element 5 being released, the rod 2 turns back to the ascending position and the seal 23 thereof closes the material discharge opening 31 of the connection base 3 again. Through repeated pressing of the pressing element 5 and each pressing reaching the terminal end of the descending position (which means the pressing element is in contact with the isolation ring 111), the amount of the seasoning falls through the material discharge opening 31 is fixed so as to achieve the quantitative seasoning dispensing.

Moreover, when the rod 2 is moved upward or downward, the pull part 22 on the rod 2 is also moved along with the rod 2. By the upward and downward movement of the pull part 22, the seasoning received in the second space 12 is stirred and moved so as to avoid caking and bridging.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A quantitative dispenser comprising:
a container body having a first space, a second space and an insertion hole connecting and between the first space and the second space; an isolation ring is disposed around a cylindrical wall of the first space and an opening of the first space is facing upward while an opening of the second space is facing downward; a threaded segment is arranged at an inner wall surface at one end of the second space, near the opening of the second space;
a rod that includes an assembly part disposed on a top end thereof while a bottom end thereof is arranged with a pull part and a seal; after being inserted into the second space of the container body, the top end of the rod is passed through the insertion hole and entered into the first space of the container body;
a connection base that includes a conical material discharge opening therein and a threaded segment on a top end thereof; the threaded segment is threaded and fastened with the threaded segment of the container body;
an elastic part that is mounted inside the first space of the container body and placed around the top end of the rod; and
a pressing element that is set on the first space of the container body and is having a receiving space and a threaded hole arranged concavely on the receiving space; the receiving space is for mounting the elastic part and having an opening facing downward while the threaded hole is for connecting and fixing the assembly part of the rod.
